(19) United States
(12) Patent Application Publication
(10) Pub. No.: US 2016/0177992 A1
(43) Pub. Date: Jun. 23, 2016

(54) Connector for Steel Reinforcing Bars

(71) Applicant: Lung-Chang Lin, Kaohsiung City (TW)

(72) Inventor: Lung-Chang Lin, Kaohsiung City (TW)

(21) Appl. No.: 14/966,010

(22) Filed: Dec. 11, 2015

(30) Foreign Application Priority Data
Dec. 19, 2014 (TW) 103222589

(51) Int. Cl. F16B 7/18

(52) U.S. Cl. CPC F16B 7/182

(57) ABSTRACT

A connector for steel reinforcing bars has a female member and at least one male member. The female member has a threaded hole. The threaded hole is formed in the female member and has at least one threaded section and a straight section. The straight section is formed in the threaded hole, communicates with the at least one threaded section, and has an inner diameter smaller than the inner diameter of the at least one threaded section. The at least one male member is connected to the female member, and each one of the at least one male member has a screw rod section, a cylindrical section, and a connecting section. The screw rod section is formed between the cylindrical section and the connecting section and is screwed with the at least one threaded section. The cylindrical section is corresponding to and mounted in the straight section.

### BACKGROUND OF THE INVENTION

1. Field of the Invention

The present invention relates to a connector, and more particularly to a connector for steel reinforcing bars that can be used easily and can connect two separate steel reinforcing bars securely with each other conveniently.

2. Description of Related Art

A conventional connector that is used to connect two separate steel reinforcing bars with each other has a female member and at least one male member. The female member has a threaded hole. Each one of the at least one male member has a screw rod. The female member and the male member are respectively and securely connected to two ends of the separate steel reinforcing bars by welding. Then, the separate steel reinforcing bars can be connected with each other by an engagement between the threaded hole of the female member and the screw rod of the male member. In addition, another conventional connector for steel reinforcing bars has a female member and two male members. The two male members are respectively connected to the two ends of the separate steel reinforcing bars by welding and are connected to the female member to enable the two separate steel reinforcing bars to connect with each other.

In order to align the screw rod of the male member with the threaded hole of the female member easily, the male member has a conical portion formed on a free end of the screw rod. In addition, the female member has a female screw line formed in the threaded hole. However, the female screw line cannot be formed fully in the threaded hole of the female member to form a straight section in an inner end of the threaded hole. Due to the conical portion of the screw rod and the straight section of the threaded hole, the screw rod cannot be fully screwed with the threaded hole at the inner end of the threaded hole, and this will shorten an engaging length between the threaded hole and the screw rod and will influence the structural strength between an engagement between the female member and the male member of the conventional connector.

To overcome the shortcomings, the present invention provides a connector for steel reinforcing bars to mitigate or obviate the aforementioned problems.

### SUMMARY OF THE INVENTION

The main objective of the present invention is to provide a connector for steel reinforcing bars that can be used easily and can connect two separate steel reinforcing bars securely with each other conveniently.

The connector for steel reinforcing bars in accordance with the present invention has a female member and at least one male member. The female member has a threaded hole. The threaded hole is formed in the female member and has at least one threaded section and a straight section. The straight section is formed in the threaded hole, communicates with the at least one threaded section, and has an inner diameter smaller than the inner diameter of the at least one threaded section. The at least one male member is connected to the female member, and each one of the at least one male member has a screw rod section, a cylindrical section, and a connecting section. The screw rod section is formed between the cylindrical section and the connecting section and is screwed with the at least one threaded section. The cylindrical section is corresponding to and mounted in the straight section.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a connector for steel reinforcing bars in accordance with the present invention;

FIG. 2 is a side view in partial section of the connector for steel reinforcing bars in FIG. 1;

FIG. 3 is an enlarged end side view of a male member of the connector in FIG. 1;

FIG. 4 is an enlarged cross sectional side view of a female member of the connector in FIG. 1;

FIG. 5 is an enlarged perspective view of a second embodiment of the female member in accordance with the present invention;

FIG. 6 is an operational side view in partial section of the connector for steel reinforcing bars in FIG. 2;

FIG. 7 is another operational side view in partial section of the connector for steel reinforcing bars in FIG. 2;

FIG. 8 is a side view in partial section of a second embodiment of a connector for steel reinforcing bars in accordance with the present invention;

FIG. 9 is an operational side view hi partial section of the connector for steel reinforcing bars in FIG. 8; and

FIG. 10 is another operational side view in partial section of the connector for steel reinforcing bars in FIG. 8.

### DETAILED DESCRIPTION OF THE PREFERRED EMBODIMENT

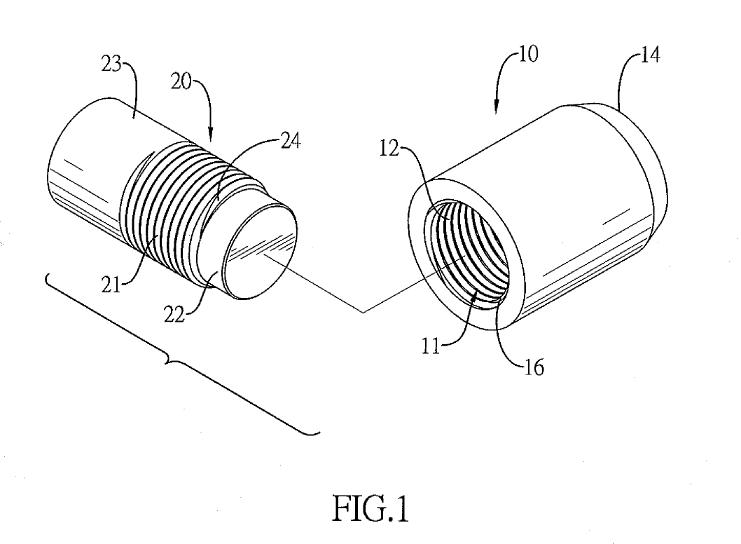

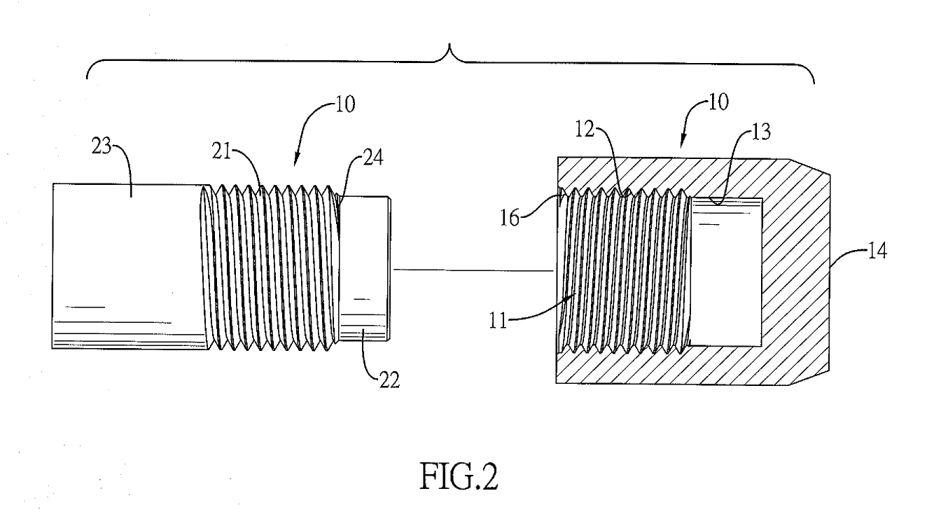

With reference to FIGS. 1 and 2, a first embodiment of a connector for steel reinforcing bars in accordance with the present invention has a female member 10 and a male member 20.

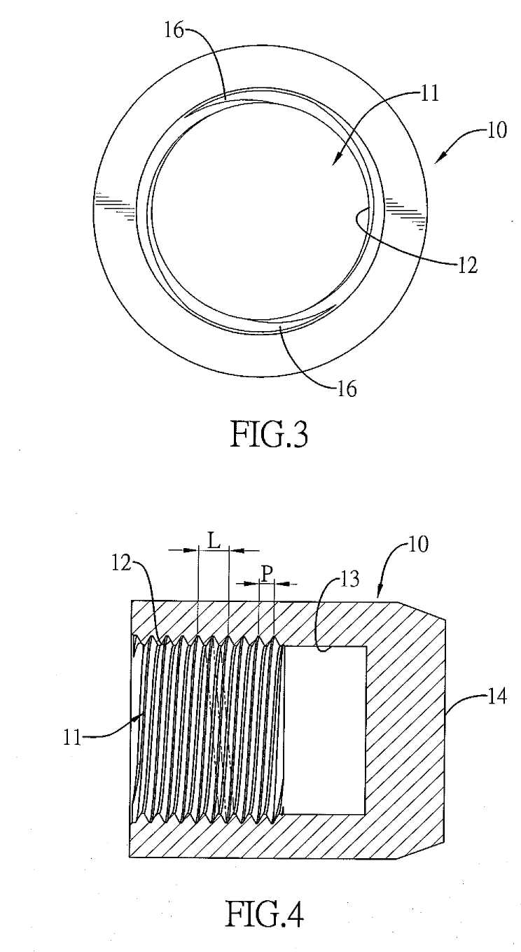

The female member 10 may be made of steel and has an open side, a closed side 14, and a threaded hole 11. The closed side 14 is opposite to the open side of the female member 10. The threaded hole 11 is formed through the open side of the female member 10 and has a threaded section 12 and a straight section 13. The threaded section 12 is formed in the threaded hole 11 adjacent to the open side of the female member 10 and has multiple female screw lines and an inner diameter. Preferably, the threaded section 12 may have two female screw lines or three female screw lines. With further reference to FIGS. 2 and 3, each one of the multiple screw lines has a thread inlet 16 formed on an end of the threaded section 12.

The straight section 13 is formed in the threaded hole 11 between the threaded section 12 and the closed side 14 of the female member 10, communicates with the threaded section 12, and has an inner diameter smaller than the inner diameter of the threaded section 12.

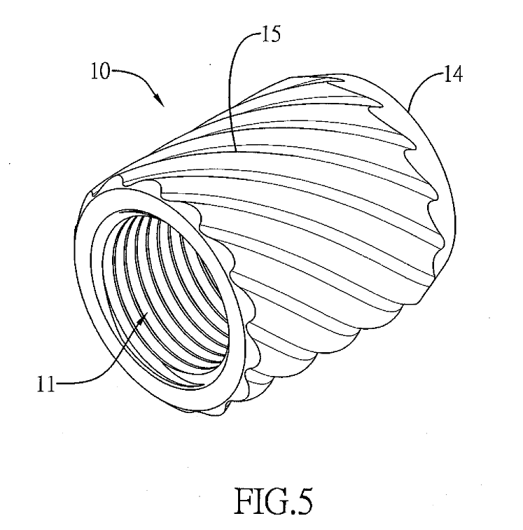

With reference to FIG. 4, according to a stability specification of connectors for steel reinforcing bars, a pitch (P) of each one of the multiple female screw lines of the female member 10 is equal to a pitch of a single female screw line of a conventional connector. That is, the number of the female screw line of the female member 10 per unit length is equal to the number of the female screw line of the conventional connector per unit length. Then, when the female member 10 has two female screw lines or three female screw lines, a distance of travel (L) of the two female screw lines is 2 times of the pitch of the single female screw line, and a distance of travel (L) of the three female screw lines is 3 times of the pitch of the single female screw line.

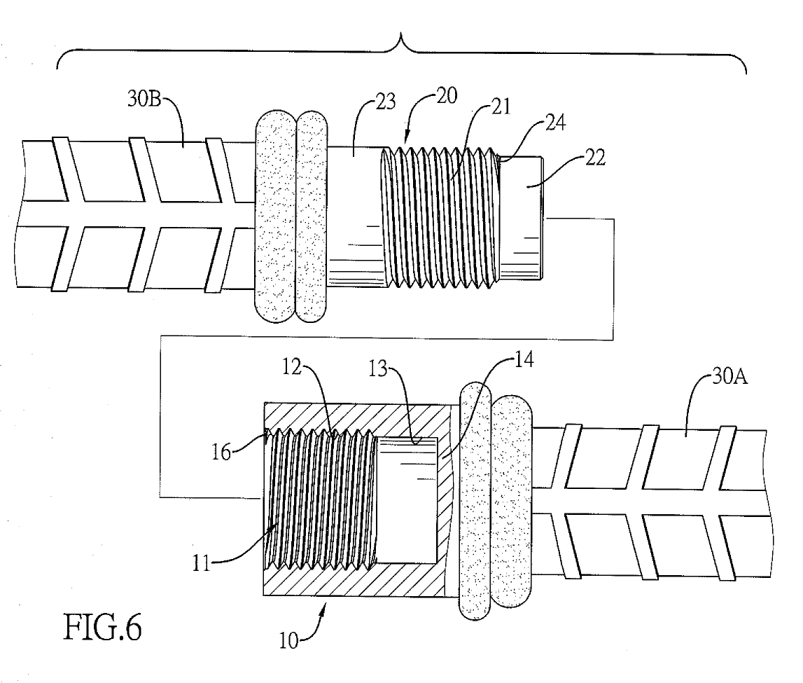

With reference to FIGS. 1 and 5, the female member 10 has an external surface, and the external surface of the female member 10 is smooth, or the female member 10 further has multiple spiral uneven flanges 15 formed on the external surface of the female member 10 to increase a connecting strength with concrete.

The male member 20 may be made of steel, is a separate element or is formed on an end of a steel reinforcing bar. The male member 20 is detachably connected to the female member 10 and has two ends, a screw rod section 21, a cylindrical section 22, and a connecting section 23.

The screw rod section 21 is formed on the male member 20 between the two ends of the male member 20, is detachably connected to the threaded section 12 of the threaded hole 11 of the female member 10, and has an outer diameter and multiple male screw lines. The male screw lines of the screw rod section 21 are corresponding to and engage with the female screw lines of the threaded section 12 of the threaded hole 11. That is, the thread type, size, pitch, and distance of travel of the male screw lines of the screw rod section 21 are corresponding to the thread type, size, pitch, and distance of travel of the female screw lines of the threaded section 12. In addition, the screw rod section 21 has multiple screw protrusions 24 formed on the screw rod section 21 adjacent to the cylindrical section 22 and corresponding to the thread inlets 16 of the threaded section 12.

The cylindrical section 22 is formed on one of the two ends of the male member 20, is formed with the screw rod section 21, and has an outer diameter smaller than the outer diameter of the screw rod section 21. The cylindrical section 22 is mounted M and corresponding to the straight section 13 of the threaded hole 11 via the threaded section 12. Preferably, a length of the cylindrical section 22 may be 0.5 to 1.5 centimeters. The connecting section 23 is formed on the other end of the male member 20 and is formed with the screw rod section 21 opposite to the cylindrical section 22.

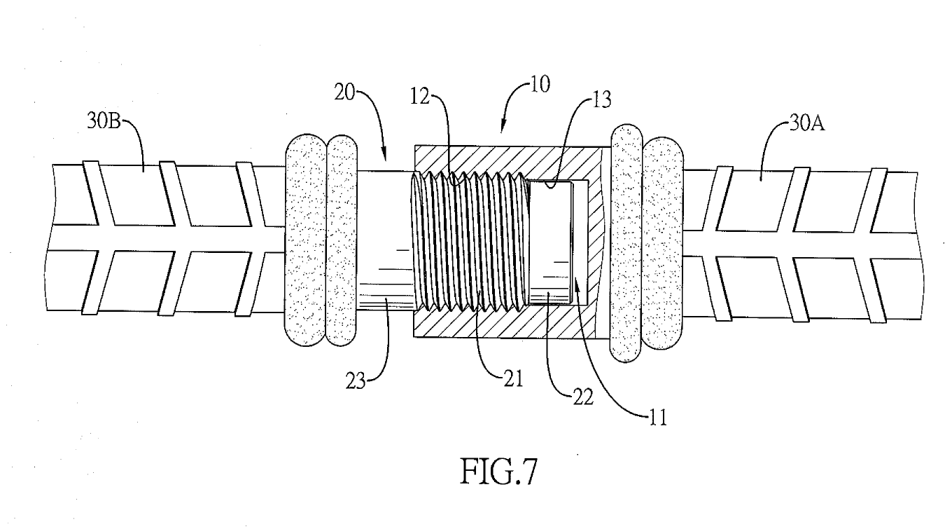

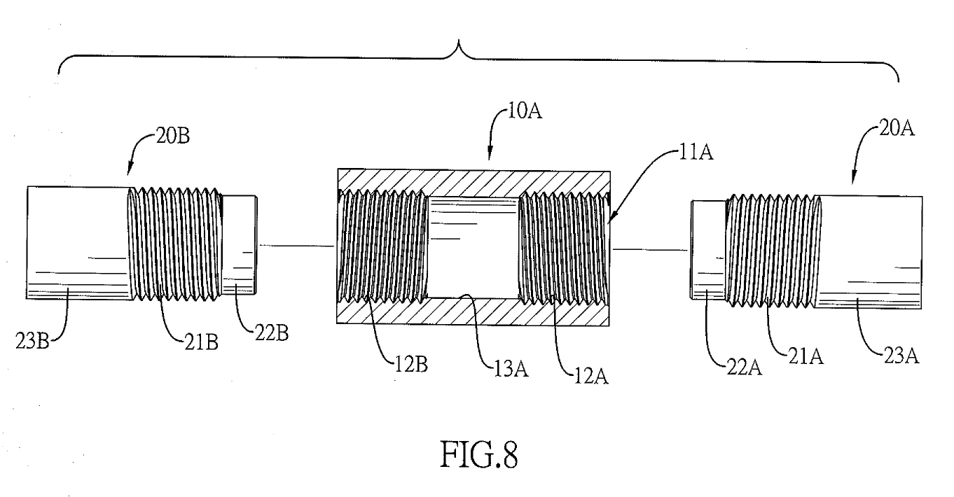

With reference to FIGS. 6 and 7, in use, the connector of the first embodiment in accordance with the present invention is connected between two steel reinforcing bars 30A, 30B, one of the steel reinforcing bars 30A, 30B is securely connected to the closed side 14 of the female member 10 by welding, and the other steel reinforcing bar 30A, 30B is securely connected to the connecting section 23 of the male member 20 by welding. Preferably, the female member 10 and the male member 20 can be also respectively and directly formed on the two ends of the steel reinforcing bars 30A, 30B.

In assembly, the cylindrical section 22 of the male member 20 that has smaller outer diameter relative to the screw rod section 21 aligns with the threaded hole 11 of the female member 10, and the screw rod section 21 is screwed with the threaded section 12 of the threaded hole 11 to enable the cylindrical section 22 to fully mount in the straight section 13. Then, the screw rod section 21 is fully screwed with the threaded section 12 of the threaded hole 11. After the cylindrical section 22 and the screw rod section 21 are respectively mounted in or connected to the straight section 13 and the threaded section 12, the two steel reinforcing bars 30A, 30B are securely connected to each other by the connector of the first embodiment in accordance with the present invention.

During the above-mentioned connecting process, the threaded hole 11 of the female member 10 has multiple thread inlets 16 adjacent to the end of the threaded section 12, and the screw rod section 21 has multiple screw protrusions 24 corresponding to the thread inlets 16 of the threaded section 12, and this can enable an end of each one of the screw protrusions 24 to easily align with and mount in one of the thread inlets 16 of the threaded hole 11 of the female member 10 in a small range of rotation angle.

For example, when the threaded section 12 of the female member 10 has two female screw lines and the screw rod section 21 of the male member 20 has two male screw lines, two thread inlets 16 and two screw protrusions 24 are respectively and evenly distributed in the threaded hole 11 in a range of 360 degrees and in the screw rod section 21 in a range of 360 degrees. Then, when the male member 20 is connected to the female member 10, the male member 20 only needs to be rotated for an angle less than 180 degrees to enable the two screw protrusions 24 to respectively align with and mount in the two thread inlets 16 of the female member 10. Similarly, when the threaded section 12 of the female member 10 has three female screw lines and the screw rod section 21 of the male member 20 has three male screw lines, three thread inlets 16 and three screw protrusions 24 are respectively and evenly distributed in the threaded hole 11 for a range of 360 degrees and in the screw rod section 21 for a range of 360 degrees. Then, when the male member 20 is connected to the female member 10, the male member 20 only needs to be rotated for an angle less than 120 degrees to enable the three screw protrusions 24 to respectively align with and mount in the three thread inlets 16 of the female member 10.

In addition, a pitch of each one of the screw lines of the threaded section 12 and the screw rod section 21 is 2 times, 3 times or integer multiples relative to a distance of travel of a single screw line of the conventional connector, and this can enable the male member 20 or the female member 10 to have a longer screwing stroke per rotating cycle to reduce the cycle number of rotating the male member 20 or the female member 10.

With reference to FIG. 8, a second embodiment of a connector for steel reinforcing bars in accordance with the present invention has a female member 10A and two male members 20A, 20B.

The female member 10A may be made of steel and has two sides and a threaded hole 11A. The threaded hole 11A is axially formed through the two sides of the female member 10A, and has two threaded sections 12A, 12B and a straight section 13A. The threaded sections 12A, 12B are formed in the female member 10A respectively adjacent to the two sides of the female member 10A, and each one of the threaded sections 12A, 12B has a screw direction, an inner diameter and multiple female screw lines. The screw directions of the two threaded sections 12A, 12B are opposite. Preferably, each one of the threaded section 12A, 12B may have two female screw lines or three female screw lines. Furthermore, each one of the two threaded sections 12A, 12B has multiple female thread inlets formed in the corresponding threaded section 12A, 12B adjacent to one of the sides of the female member 10A. The straight section 13A is formed in the threaded hole 11A between the two threaded sections 12A, 12B, communicates with the threaded sections 12A, 12B, and has an inner diameter. The inner diameter of the straight section 13A is smaller than the inner diameter of each one of the threaded sections 12A, 12B.

The two male members 20A, 20B may be made of steel, are separate elements or are respectively formed on two ends of the steel reinforcing bars 30A, 30B. The two male members 20A, 20B are detachably connected to the female member 10A, and each one of the two male members 20A, 20B has two ends, a screw rod section 21A, 21B, a cylindrical section 22A, 22B, and a connecting section 23A, 23B.

The screw rod section 21A, 21B is formed on the male member 20A, 20B between the two ends of the male member 20A, 20B, is detachably connected to one of the threaded sections 12A, 12B of the threaded hole 11A of the female member 10A, and has an outer diameter, a screw direction, and multiple male screw lines. The screw directions of the screw rod sections 21A, 21B of the two male members 20A, 20B are opposite, and are respectively corresponding to the screw directions of the threaded sections 12A, 12B of the threaded hole 11A. The male screw lines of the screw rod section 21A, 21B are corresponding to and engage with the female screw lines of a corresponding threaded section 12A, 12B of the threaded hole 11A. In addition, the screw rod section 21A, 21B has multiple screw protrusions formed on the screw rod section 21A, 21B adjacent to the cylindrical section 22A, 22B and corresponding to the thread inlets of the corresponding threaded section 12A, 12B of the threaded hole 11A.

The cylindrical section 22A, 22B is formed on one of the two ends of the male member 20A, 20B, is formed with the screw rod section 21A, 21B, and has an outer diameter smaller than the outer diameter of the screw rod section 21A, 21B. The cylindrical section 22A, 22B is mounted in and corresponding to the straight section 13A of the threaded hole 11A via one of the threaded sections 12A, 12B. Preferably, a length of the cylindrical section 22A, 22B may be 0.5 to 1.5 centimeters. The connecting section 23A, 23B is formed on the other end of the male member 20A, 20B, and is formed with the screw rod section 21A, 21B opposite to the cylindrical section 22A, 22B.

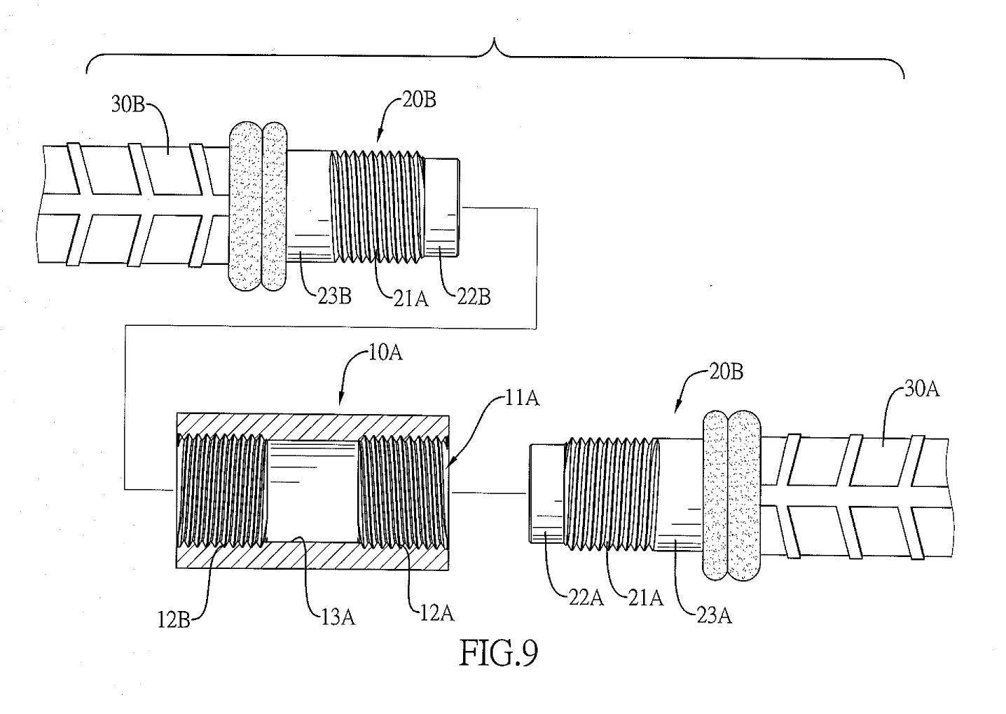

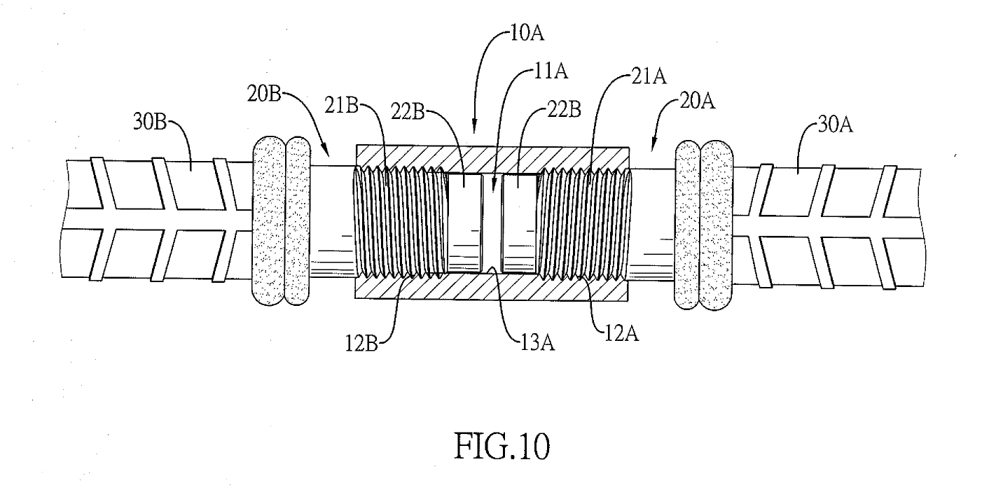

In use, with reference to FIGS. 9 and 10, the connector of the second embodiment in accordance with the present invention is connected between the two steel reinforcing bars 30A, 30B, and the two steel reinforcing bars 30A, 30B are respectively and securely connected to the connecting sections 23A, 23B of the two male members 20A, 20B by welding. Preferably, the two male members 20 can also be respectively and directly formed on the two ends of the steel reinforcing bars 30A, 30B.

In assembly, the cylindrical sections 22A, 22B of the male members 20A, 20B that have smaller outer diameters relative to the screw rod sections 21A, 21B respectively align with the two threaded sections 12A, 12B of the threaded hole 11A of the female member 10A, and the screw rod sections 21A, 21B are respectively screwed with the threaded sections 12A, 12B of the threaded hole 11A to enable the cylindrical sections 22 to fully mount in the straight section 13A of the threaded hole 11A. Then, the screw rod sections 21A, 21B are fully screwed with the threaded sections 12A, 12B of the threaded hole 11A. After the cylindrical sections 22A, 22B and the screw rod sections 21A, 21B are respectively mounted in or connected to the straight section 13A and the threaded sections 12A, 12B, the two steel reinforcing bars 30A, 30B are securely connected to each other by the connector of the second embodiment in accordance with the present invention.

According to the above-mentioned features and structural relationships, in the connector for steel reinforcing bars 30A, 30B in accordance with the present invention, the female member 10, 10A is connected to one or two male connectors 20, 20A, 20B to connect the two steel reinforcing bars 30A, 30B with each other. Additionally, the cylindrical section 22, 22A, 22B of the male member 20, 20A, 20B has an outer diameter smaller than the outer diameter of the screw rod section 21, 21A, 21B, and this can enable the cylindrical section 22, 22A, 22B to align with the threaded hole 11, 11A easily and to provide a guiding effect to the screw rod section 21, 21A, 21B. Then, the at least one male member 20, 20A, 20B can be connected with the female member 10, 10A easily. Then, the steel reinforcing bars 30A, 30B can be securely and conveniently connected with each by the connector in accordance with the present invention.

In addition, since the cylindrical section 22, 22A, 22B is fully mounted in the straight section 13, 13A, this can enable the screw rod section 21, 21A, 21B to be fully screwed with the corresponding threaded section 12, 12A, 12B to increase an engaging length between the threaded section 12, 12A, 12B and the screw rod section 21, 21A, 21B and to improve the structural strength between an engagement between the female member 10, 10A and the male member 20, 20A, 20B of the connector in accordance with the present invention.

Furthermore, a pitch (P) of each one of the screw lines of the threaded section 12, 12A, 12B and the screw rod section 21, 21A, 21B is 2 times, 3 times or integer multiples relative to a distance of travel of a single screw line of the conventional connector, and this can enable the male member 20, 20A, 20B or the female member 10, 10A to have a longer screwing stroke per rotating cycle to reduce the cycle number of rotating the male member 20, 20A, 20B or the female member 10, 10A.

Additionally, the female member 10 further has multiple spiral uneven flanges 15 formed on the external surface of the female member 10 to increase a connecting strength with concrete.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A connector for steel reinforcing bars having:
a female member having
an open side;
a closed side being opposite to the open side of the female member; and
a threaded hole formed through the open side of the female member opposite to the closed side of the female member, and having
a threaded section formed in the threaded hole adjacent to the open side of the female member and having
multiple female screw lines, and each one of the multiple female screw lines having a thread inlet formed on an end of the threaded section; and
an inner diameter; and
a straight section formed in the threaded hole between the threaded section and the closed side of the female member, communicating with the threaded section, and having an inner diameter smaller than the inner diameter of the threaded section; and
a male member detachably connected to the female member and having
two ends;
a screw rod section formed on the male member between the two ends of the male member, detachably connected to the threaded section of the threaded hole of the female member, and having
an outer diameter; and
multiple male screw lines corresponding to and engaging with the female screw lines of the threaded section of the threaded hole; and
multiple screw protrusions formed on the screw rod section and corresponding to the thread inlets of the threaded section; and
a cylindrical section formed on one of the two ends of the male member, formed with the screw rod section, mounted in and corresponding to the straight section of the threaded hole via the threaded section, and having an outer diameter smaller than the outer diameter of the screw rod section; and
a connecting section formed on the other end of the male member and formed with the screw rod section opposite to the cylindrical section.

2. The connector for steel reinforcing bars as claimed in claim 1, wherein the female member has
an external surface; and
multiple spiral uneven flanges formed on the external surface of the female member.

3. A connector for steel reinforcing bars having:
a female member having
two sides; and
a threaded hole axially formed through the two sides of the female member, and having
two threaded sections formed in the female member respectively adjacent to the two sides of the female member, and each one of the threaded sections having
a screw direction, and the screw directions of the two threaded sections being opposite;
an inner diameter;
multiple female screw lines, and each one of the multiple female screw lines having a thread inlet formed on an end of the threaded section; and
a straight section formed in the threaded hole between the two threaded sections, communicating with the two threaded sections, and having an inner diameter smaller than the inner diameter of each one of the threaded sections; and
two male members detachably connected to the female member, and each one of the two male members having
two ends;
a screw rod section formed on the male member between the two ends of the male member, detachably connected to one of the threaded sections of the threaded hole of the female member, and having
an outer diameter;
multiple male screw lines corresponding to and engaging with the female screw lines of one of the threaded sections of the threaded hole;
multiple screw protrusions formed on the screw rod section and corresponding to the thread inlets of one of the threaded sections;
a screw direction; and
wherein the screw directions of the screw rod sections of the two male members are opposite, and are respectively corresponding to the screw directions of the two threaded sections of the threaded hole;
a cylindrical section formed on one of the two ends of the male member, formed with the screw rod section, mounted in and corresponding to the straight section of the threaded hole via one of the threaded sections, and having an outer diameter smaller than the outer diameter of the screw rod section; and
a connecting section formed on the other end of the male member, and formed with the screw rod section opposite to the cylindrical section.

4. The connector for steel reinforcing bars as claimed in claim 3, wherein the female member has
an external surface; and
multiple spiral uneven flanges formed on the external surface of the female member.
